(19) United States
(12) Patent Application Publication
(10) Pub. No.: US 2020/0392654 A1
(43) Pub. Date: Dec. 17, 2020

(54) NANOMATERIAL-COATED FIBERS

(71) Applicant: MESOMAT INC, Hamilton (CA)

(72) Inventors: Paul Fowler, Hamilton (CA); Charlotte Demonsant, Paris (FR); Adrien Dangremont, Arcueil (FR); Rafael Schulman, Hamilton (CA); Karolyi J. T. Dalnokl-Veress, Hamilton (CA); Clare Lindsay Armstrong, Hamilton (CA)

(21) Appl. No.: 16/977,711

(22) PCT Filed: Feb. 28, 2019
(86) PCT No.: PCT/IB2019/051634

§ 371 Date: Sep. 2, 2020

Related U.S. Application Data
(60) Provisional application No. 62/637,699, filed on Mar. 2, 2018.

(51) Int. Cl. D02G 3/44; D02G 3/36; D06M 11/74; D06M 11/83; D06M 23/08; H01B 1/20

(52) U.S. Cl. CPC D02G 3/441; D02G 3/36; D06M 11/74; B82Y 30/00; D06M 23/08; H01B 1/20; D06M 11/83

(57) ABSTRACT

Nanomaterial-coated fibers and methods of manufacture thereof are provided. A nanomaterial-coated fiber includes a stretchable fiber core and a mesh of high aspect ratio nanomaterials coated around the stretchable fiber core. The mesh imparts a material property to the nanomaterial-coated fiber continuous throughout a length of the nanomaterial-coated fiber. The mesh maintains the material property upon stretching of the length of the nanomaterial-coated fiber. A nanomaterial-coated fiber is produced by obtaining a stretchable fiber core, coating the stretchable fiber core with high aspect ratio nanomaterials, and forming a mesh of the high aspect ratio nanomaterials around the stretchable fiber core. The mesh may be electrically conductive to impart electrical conductivity to the nanomaterial-coated fiber. Nanomaterial-coated fibers may be wound into a yarn.

### FIELD

The present disclosure relates generally to materials, and in particular to fibrous materials.

### BACKGROUND

Fibrous materials are formed from a combination of fibers. A fiber is a natural or synthetic substance that is significantly longer than it is wide. Natural fibers include plant fibers, wood fibers, and other naturally occurring fibers. Synthetic fibers include metallic fibers, carbon fibers, polymer fibers, and microfibers, among others. Many fibers are used in textiles production.

A synthetic fiber may be engineered to possess a certain material property suitable for a given application. For example, a synthetic fiber may be designed to possess a certain density, tensile strength, elastic modulus, water absorption, or other property. A synthetic fiber possessing a certain material property may impart that material property, or a similar material property, to a fibrous material or physical article into which the synthetic fiber is incorporated.

### SUMMARY

According to an aspect of the specification, a nanomaterial-coated fiber includes a stretchable fiber core and a mesh of high aspect ratio nanomaterials coated around the stretchable fiber core. The mesh is to impart a material property to the nanomaterial-coated fiber continuous throughout a length of the nanomaterial-coated fiber and to maintain the material property upon stretching of the length of the nanomaterial-coated fiber.

According to another aspect of the specification, a yarn of nanomaterial-coated fibers includes a first stretchable fiber core, a second stretchable fiber core wound together with the first stretchable fiber core to form a yarn, and a mesh of high aspect ratio nanomaterials coated around the yarn and between the first stretchable fiber core and the second stretchable fiber core. The mesh is to impart a material property to the yarn of nanomaterial-coated fibers continuous throughout a length of the yarn of nanomaterial-coated fibers and to maintain the material property upon stretching of the length of the yarn of nanomaterial-coated fibers.

According to another aspect of the specification, a method for producing a nanomaterial-coated fiber includes obtaining a stretchable fiber core, coating the stretchable fiber core with high aspect ratio nanomaterials, and forming a mesh of the high aspect ratio nanomaterials around the stretchable fiber core. The mesh imparts a material property to the nanomaterial-coated fiber continuous throughout a length of the nanomaterial-coated fiber and maintains the material property upon stretching of the length of the nanomaterial-coated fiber.

According to another aspect of the specification, a method for producing a yarn of nanomaterial-coated fibers includes obtaining a first stretchable fiber core, obtaining a second stretchable fiber core, coating the first stretchable fiber core with high aspect ratio nanomaterials, coating the second stretchable fiber core with high aspect ratio nanomaterials, winding together the first stretchable fiber core and the second stretchable fiber core to form a yarn, and forming a mesh of the high aspect ratio nanomaterials around the yarn and between the first stretchable fiber core and the second stretchable fiber core. The mesh imparts a material property to the yarn of nanomaterial-coated fibers continuous throughout a length of the yarn of nanomaterial-coated fibers and maintains the material property upon stretching of the length of the yarn of nanomaterial-coated fibers.

According to another aspect of the specification, an electrically conductive nanomaterial-coated fiber includes a stretchable fiber core and an electrically conductive mesh of electrically conductive high aspect ratio nanomaterials coated around the stretchable fiber core. The electrically conductive mesh is to conduct electricity throughout a length of the electrically conductive nanomaterial-coated fiber and to maintain electrical conductivity upon stretching of the length of the electrically conductive nanomaterial-coated fiber.

According to another aspect of the specification, a yarn of electrically conductive nanomaterial-coated fibers includes a first stretchable fiber core, a second stretchable fiber core wound together with the first stretchable fiber core to form a yarn, and an electrically conductive mesh of electrically conductive high aspect ratio nanomaterials coated around the yarn and between first stretchable fiber core and the second stretchable fiber core. The electrically conductive mesh is to conduct electricity throughout a length of the yarn of electrically conductive nanomaterial-coated fibers and to maintain electrical conductivity upon stretching of the length of the yarn of electrically conductive nanomaterial-coated fibers.

According to another aspect of the specification, a method for producing an electrically conductive nanomaterial-coated fiber includes obtaining a stretchable fiber core, coating the stretchable fiber core with electrically conductive high aspect ratio nanomaterials, and forming an electrically conductive mesh of the electrically conductive high aspect ratio nanomaterials around the stretchable fiber core. The electrically conductive mesh is continuously conductive throughout a length of the nanomaterial-coated fiber and maintains conductivity upon stretching of the length of the nanomaterial-coated fiber.

According to another aspect of the specification, a method for producing a yarn of electrically conductive nanomaterial-coated fibers includes obtaining a first stretchable fiber core, obtaining a second stretchable fiber core, coating the first stretchable fiber core with electrically conductive high aspect ratio nanomaterials, coating the second stretchable fiber core with electrically conductive high aspect ratio nanomaterials, winding together the first stretchable fiber core and the second stretchable fiber core to form a yarn, and forming an electrically conductive mesh of the electrically conductive high aspect ratio nanomaterials around the yarn and between the first stretchable fiber core and the second stretchable fiber core. The electrically conductive mesh is continuously conductive throughout a length of the nanomaterial-coated fiber and maintains conductivity upon stretching of the length of the nanomaterial-coated fiber.

### BRIEF DESCRIPTION OF THE DRAWINGS

FIG. 1 is an illustration of a segment of an example nanomaterial-coated fiber.

FIG. 2 is a microscopy image of a segment of an example nanomaterial-coated fiber.

FIG. 3 is a close-up microscopy image of a segment of an example nanomaterial-coated fiber.

FIG. 4A is an illustration of a segment of an example nanomaterial-coated fiber. FIG. 4B is a close-up microscopy image of a portion of a mesh of an example nanomaterial-coated fiber similar to the mesh of the nanomaterial-coated fiber of FIG. 4A.

FIG. 5A is an illustration of a segment of an example nanomaterial-coated fiber, the nanomaterial coated fiber including a mesh of high aspect ratio nanomaterials skewed toward alignment with a circumferential direction perpendicular to a length of the nanomaterial-coated fiber. FIG. 5B is a close-up microscopy image of a portion of a mesh of an example nanomaterial-coated fiber similar to the mesh of the nanomaterial-coated fiber of FIG. 5A.

FIG. 6A is an illustration of a segment of an example nanomaterial-coated fiber. FIG. 6B is an illustration of the segment of the nanomaterial-coated fiber of FIG. 6A stretched along its length. FIG. 6C is an illustration of the segment of the nanomaterial-coated fiber of FIG. 6A compressed along its length.

FIG. 7 is a flowchart of an example method for producing a nanomaterial-coated fiber.

FIG. 8 is an illustration of a segment of an example yarn of nanomaterial-coated fibers.

FIG. 9 is a microscopy image of a segment of an example yarn of nanomaterial-coated fibers.

FIG. 10 is an illustration of a segment of an example yarn of nanomaterial-coated fibers, the yarn covered by an insulative layer.

FIG. 11 is a flowchart of an example method for producing a yarn of nanomaterial-coated fibers.

FIG. 12 is a schematic diagram of an example apparatus for producing a nanomaterial-coated fiber.

FIG. 13 is a plot showing the electrical resistance of an example yarn of nanomaterial-coated fibers as a function of strain.

FIG. 14 is a plot showing the electrical resistance of an example yarn of nanomaterial-coated fibers across a series of elongation cycles.

### DETAILED DESCRIPTION

A fibrous material may be made of several fibers which each possess a desirable material property and which combine to impart a desirable overall material property to the fibrous material. However, the several fibers may also impart an undesirable material property to the fibrous material as a side effect. For example, several metal fibers, each being electrically conductive, may combine to produce a fibrous material that is also, desirably, electrically conductive overall. However, the metal fibers may make the fibrous material undesirably rigid and therefore unusable for certain applications such as stretchable electronics.

The nanomaterial coating of fibers may enable the production of fibrous materials which possess a desirable material property imparted by the fibers while mitigating side effects of undesirable material properties that may otherwise be imparted by the fibers. A fiber core may be coated with high aspect ratio nanomaterials which combine to form a mesh around the fiber core to impart a desirable material property to the fiber overall. Imparting the desirable material property via the mesh obviates the need for the fiber core itself to possess the desirable material property. The fiber core itself may thereby possess additional desirable material properties or avoid possessing undesirable material properties which may otherwise impart an undesirable side effect to the fibrous material.

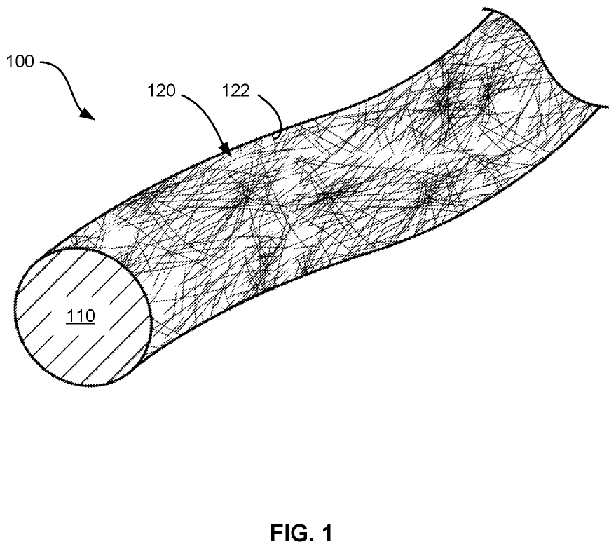

FIG. 1 is an illustration of a segment of an example nanomaterial-coated fiber 100, shown partly in cross-section. The nanomaterial-coated fiber 100 includes a stretchable fiber core 110 and a mesh 120 of high aspect ratio nanomaterials 122 coated around the stretchable fiber core 110.

The stretchable fiber core 110 is stretchable in that it is flexible, bendable, deformable, and may be elongated or compressed to a substantial degree without breaking. The stretchable fiber core 110 may be preferably stretchable by at least about 10 percent, more preferably at least about 30 percent, and more preferably at least about 50 percent. The stretchable fiber core 110 may have a radius of less than about 1 millimeter, and thus may be termed a microfiber, and preferably the stretchable fiber core 110 may have a radius between about 1 and about 500 micrometers.

The stretchable fiber core 110 may include any stretchable material, such as a polymeric material. For example, the polymeric material may include one or a combination of polystyrene, poly(methyl methacrylate), poly(n-butyl methacrylate), polyamide, polyester, polyvinyl, polyolefin, acrylic polymer, polyurethane, and thermoplastic polyurethane (TPU).

The mesh 120 is to impart a material property to the nanomaterial-coated fiber 100 continuous throughout a length of the nanomaterial-coated fiber 100. The mesh 120 is further to maintain the material property upon stretching of the length of the nanomaterial-coated fiber 100. In other words, as the nanomaterial-coated fiber 100 is stretched, bent, or otherwise deformed, the mesh 120 remains sufficiently continuous to maintain impartation of the material property to the nanomaterial-coated fiber 100. In some examples, maintenance of the material property in spite of deformation may be achieved by the high aspect ratio nanomaterials 122 remaining in contact throughout the deformation.

The high aspect ratio nanomaterials 122 include, in other words, slender nanomaterial deposits which are substantially greater in length than in width or diameter. The high aspect ratio nanomaterials 122 may have an average length-to-diameter aspect ratio of at least about 50:1, or more preferably at about 500:1, more preferably still about 1000:1, more preferably still 10,000:1. High aspect ratio nanomaterials 122 having an average length-to-diameter aspect ratio of about 1,000,000:1, or greater, may be used. The high aspect ratio nanomaterials 122 may have an average diameter of less than about 50 nanometers.

The material property imparted by the mesh 120 may include any material property attributable to the overall nanomaterial-coated fiber 100 that emerges as a result of the cooperation of a plurality of high aspect ratio nanomaterials 122 having certain properties and forming a mesh 120 around a stretchable fiber core 110. The mesh 120 may span the entire length of the nanomaterial-coated fiber 100, or at least a length of a segment thereof, to impart the material property to a length of the nanomaterial-coated fiber 100.

For example, the high aspect ratio nanomaterials 122 may be electrically conductive, and the material property may be electrical conductivity. In other words, the electrical conductivity of each individual high aspect ratio nanomaterial 122 is combined to impart overall electrical conductivity to the nanomaterial-coated fiber 100. In such examples, the nanomaterial-coated fiber 100 may be termed an electrically conductive nanomaterial-coated fiber. Such an electrically conductive nanomaterial-coated fiber includes a stretchable fiber core and an electrically conductive mesh of electrically conductive high aspect ratio nanomaterials coated around the stretchable fiber core, the electrically conductive mesh to conduct electricity throughout a length of the electrically conductive nanomaterial-coated fiber, the electrically conductive mesh further to maintain electrical conductivity upon stretching of the length of the electrically conductive nanomaterial-coated fiber. In such examples, conductivity of the electrically conductive mesh is maintained in spite of deformation by the electrically conductive high aspect ratio nanomaterials remaining in contact throughout the deformation.

Where the high aspect ratio nanomaterials 122 are electrically conductive, the nanomaterial-coated fiber 100 may be used in the production of stretchable wiring, electrically conductive textiles, wearable technologies, such as for sports or medical sensing, and in the development of flexible electronics, where there is a desire for materials where which are lightweight, durable, and remain electrically conductive while stretched or otherwise deformed. The high aspect ratio nanomaterials 122 may be designed to possess other desirable material properties other than electrical conductivity. For example, for heating applications, the high aspect ratio nanomaterials 122 may be designed to possess high thermal conductivity and high electrical resistivity, and such high aspect ratio nanomaterials 122 may be used in the production of heating wires to be used in clothing, airplane wings, or other applications in which flexible heating wires may be desirable. As another example, the high aspect ratio nanomaterials 122 may have a material property of chemical resistance for use in the production of protective garments.

Where the high aspect ratio nanomaterials 122 are electrically conductive, the high aspect ratio nanomaterials 122 may include metallic compounds or elements such as copper, silver, gold, platinum, iron in nanowire form, carbon nanotubes, other high aspect-ratio nanoparticles, and other high aspect-ratio nanomaterials. High aspect ratio nanomaterials 122, as incorporated in a coating material to coat a stretchable fiber core 110, may be in the dry solid form of powder of the high aspect ratio nanomaterials 122 or may be dispersed in solution.

The nanomaterial-coated fiber 100 may further include a treatment layer around the mesh 120 of high aspect ratio nanomaterials 122. For example, the nanomaterial-coated fiber 100 may be chemically treated to enhance adhesion of the mesh 120 to the stretchable fiber core 110. As another example, the nanomaterial-coated fiber 100 may be treated with a layer of insulative material to form an insulative coating around the mesh 120. An insulative treatment layer, as incorporated into a coating material to coat nanomaterial-coated fiber 100, may include polystyrene, poly(methyl methacrylate), poly(n-butyl methacrylate), polyamides, polyesters, polyvinyls, polyolefins, acrylic polymers, polyurethanes or thermoplastic polyurethanes (TPU). An insulative treatment layer may provide electrical insulation in examples where the high aspect ratio nanomaterials 122 are electrically conductive, or may provide protective insulation such as chemical resistance. An insulative treatment layer may be selected for stretch ability, and thus may be selected to have similar stretchability as the stretchable fiber core 110.

Thus, a nanomaterial-coated fiber 100 may be highly compliant, highly elastic, and where the mesh 120 is electrically conductive, highly conductive. For example, the nanomaterial-coated fiber 100 may have a bending modulus of less than about 1 gigapascal (GPa), may withstand strain of about 10%, 30%, or 50% without breaking, and may maintain resistivity below about 1000 ohm/cm, or more preferably about 1 ohm/cm.

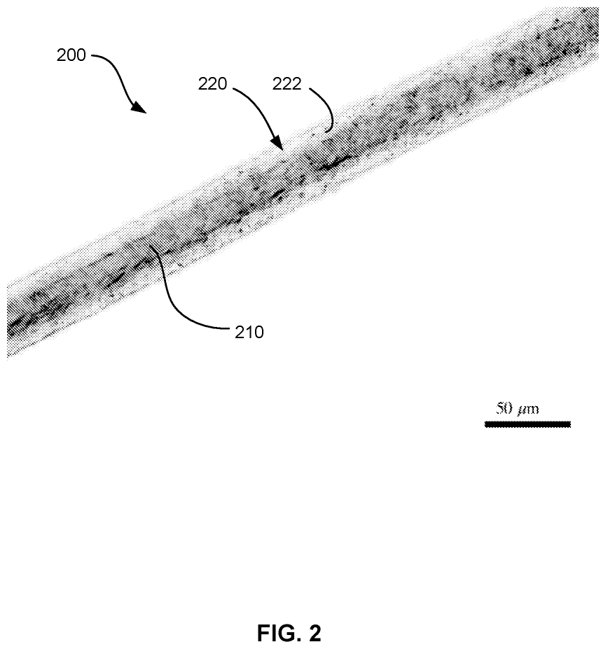

FIG. 2 is a microscopy image of a segment of an example nanomaterial-coated fiber 200. The microscopy image was captured using optical microscopy. The nanomaterial-coated fiber 200 shown is similar to the nanomaterial-coated fiber 100 of FIG. 1, and thus includes a stretchable fiber core 210 and a mesh 220 of high aspect ratio nanomaterials 222. For further description of the above elements, description of the nanomaterial-coated fiber 100 of FIG. 1 may be referenced.

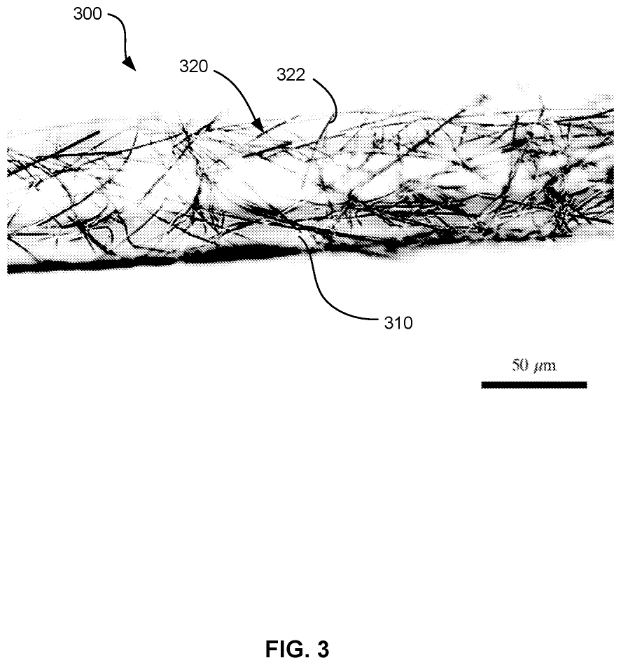

FIG. 3 is a close-up microscopy image of a segment of an example nanomaterial-coated fiber 300. The microscopy image was captured using optical microscopy. The nanomaterial-coated fiber 300 shown is similar to the nanomaterial-coated fiber 100 of FIG. 1, and thus includes a stretchable fiber core 310 and a mesh 320 of high aspect ratio nanomaterials 322. For further description of the above elements, description of the nanomaterial-coated fiber 100 of FIG. 1 may be referenced.

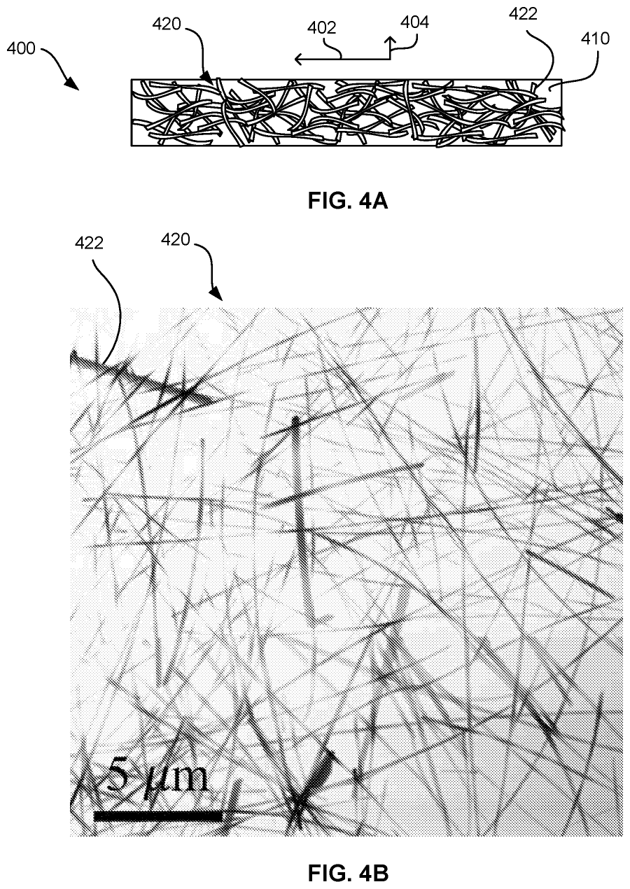

FIG. 4A is an illustration of a segment of an example nanomaterial-coated fiber 400. The nanomaterial-coated fiber 400 is similar to the nanomaterial-coated fiber 100 of FIG. 1, and thus includes a stretchable fiber core 410 and a mesh 420 of high aspect ratio nanomaterials 422. For further description of the above elements, description of the nanomaterial-coated fiber 100 of FIG. 1 may be referenced. The nanomaterial-coated fiber 400 includes a longitudinal direction 402 and a circumferential direction 404 travelling around the circumference of the stretchable fiber core 410. The high aspect ratio nanomaterials 422 are arranged randomly in the mesh 420. The high aspect ratio nanomaterials 422 therefore overlap and contact other high aspect ratio nanomaterials 422 in random arrangements.

FIG. 4B is a close-up microscopy image of a portion of a mesh of an example nanomaterial-coated fiber similar to the mesh 420 of the nanomaterial-coated fiber 400. The microscopy image was captured using atomic force microscopy. The high aspect ratio nanomaterials 422 are shown arranged randomly in the mesh 420. The high aspect ratio nanomaterials 422 therefore overlap and contact other high aspect ratio nanomaterials 422 in random arrangements.

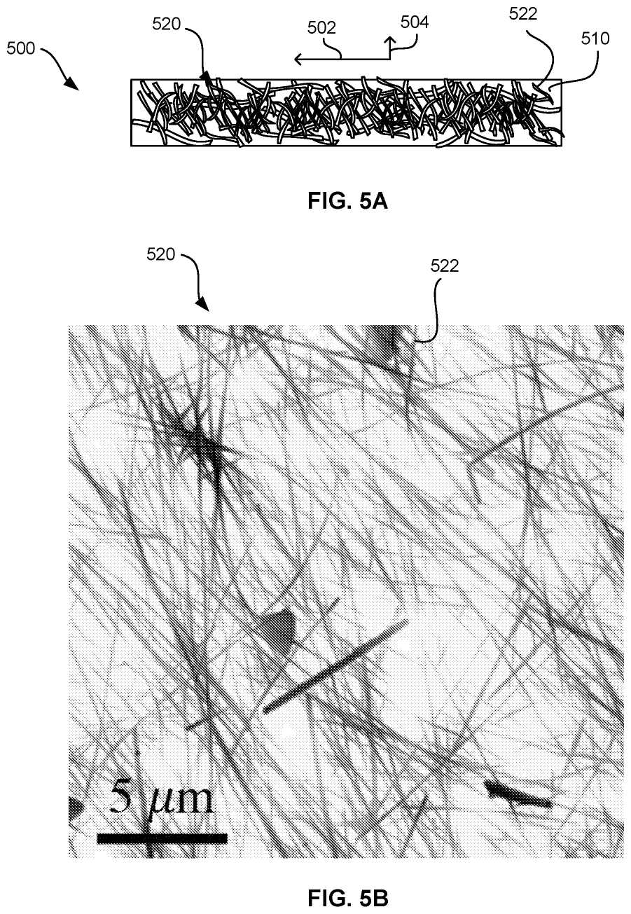

FIG. 5A is an illustration of a segment of an example nanomaterial-coated fiber 500. The nanomaterial-coated fiber 500 is similar to the nanomaterial-coated fiber 100 of FIG. 1, and thus includes a stretchable fiber core 510 and a mesh 520 of high aspect ratio nanomaterials 522. For further description of the above elements, description of the nanomaterial-coated fiber 100 of FIG. 1 may be referenced. The nanomaterial-coated fiber 500 includes a longitudinal direction 502 and a circumferential direction 504 travelling around the circumference of the stretchable fiber core 510. In contrast to the nanomaterial-coated fiber 400 of FIG. 4A, the high aspect ratio nanomaterials 522 are skewed toward alignment with the circumferential direction 504, the circumferential direction 504 being perpendicular to the longitudinal direction 502, and therefore the length, of the nanomaterial-coated fiber 500.

FIG. 5B is a close-up microscopy image of a portion of a mesh of an example nanomaterial-coated fiber similar to the mesh 520 of the nanomaterial-coated fiber 500. The microscopy image was captured using atomic force microscopy. The high aspect ratio nanomaterials 522 are shown arranged skewed toward alignment with the circumferential direction 504.

Where the high aspect ratio nanomaterials 522 are electrically conductive, a mesh 520 skewed toward alignment with the circumferential direction 504 may better retain electrical conductive connections in the longitudinal direction 502 along the length of the nanomaterial-coated fiber 500 upon stretching, flexing, or other deformation.

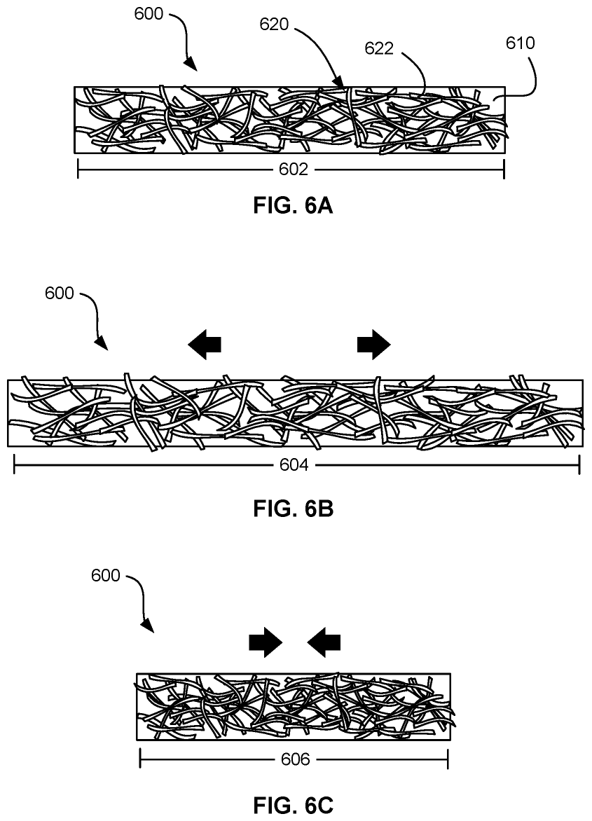

FIG. 6A is an illustration of a segment of an example nanomaterial-coated fiber 600. The nanomaterial-coated fiber 600 is similar to the nanomaterial-coated fiber 100 of FIG. 1, and thus includes a stretchable fiber core 610 and a mesh 620 of high aspect ratio nanomaterials 622. For further description of the above elements, description of the nanomaterial-coated fiber 100 of FIG. 1 may be referenced. As shown, the nanomaterial-coated fiber 600 has a first length 602 in the longitudinal direction.

FIG. 6B is an illustration of the segment of the nanomaterial-coated fiber 600 stretched along its length, and thus has a second length 604 in the longitudinal direction, the second length 604 being greater than the first length 602. The mesh 620 substantially maintains an interconnected mesh structure during and after elongation.

FIG. 6C is an illustration of the segment of the nanomaterial-coated fiber 600 compressed along its length, and thus has a third length 606 in the longitudinal direction, the third length being lesser than the first length 602 and the second length 604. The mesh 620 substantially maintains an interconnected mesh structure during and after compression.

As illustrated, the mesh 620 of the nanomaterial-coated fiber 600 maintains continuity during and after stretching and compression of the nanomaterial-coated fiber 600.

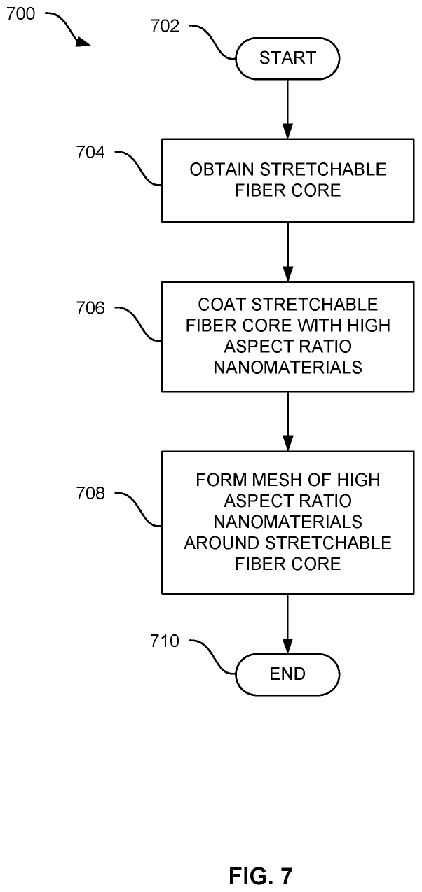

FIG. 7 is a flowchart of an example method 700 for producing a nanomaterial-coated fiber. The method 700 may be used to produce a nanomaterial-coated fiber such as, for example, the nanomaterial-coated fiber 100 of FIG. 1. Thus, the method 700 may be used to produce an electrically conductive nanomaterial-coated fiber. The method 700 begins at block 702.

At block 704, a stretchable fiber core is obtained. The stretchable fiber core may be similar to the stretchable fiber core 110 of FIG. 1. The material of the stretchable fiber core may be selected from any of the example materials provided with respect to the stretchable fiber core 110 of FIG. 1. In some examples, a polymeric starting material may be maintained a reservoir, for example as a pellet, cylindrical filament, or spool of fiber, heated in a heating unit, and extruded from the heating unit at a desired diameter. In such examples, various wheels, pulling elements, and other mechanical implements may guide the material through a formation process to produce the stretchable fiber core. For example, a 1 mm-diameter spool of TPU may be heated between about 210 C and 240 C and extruded through a nozzle at a diameter of about 0.5 mm. A pulling element may include a cylindrically collecting rotating spool. In an example in which the polymeric starting material is TPU, stretchable fiber cores with radii ranging from about 5 to about 100 micrometers may be produced by feeding the TPU into a heating element at speeds ranging from about 0.01 cm/s to about 0.025 cm/s and drawing the extruded liquid onto a cylinder which is rotating at speeds between about 1.8 m/s and about 4.5 m/s.

At block 706, the stretchable fiber core is coated with high aspect ratio nanomaterials. The high aspect ratio nanomaterials may be similar to the high aspect ratio nanomaterials 122 of FIG. 1. Where the method 700 is used to produce an electrically conductive nanomaterial-coated fiber, the high aspect ratio nanomaterials are electrically conductive, and thus may be selected from the list of electrically conductive high aspect ratio nanomaterials discussed above with respect to the high aspect ratio nanomaterials 122 of FIG. 1.

The coating may involve passing the stretchable fiber core through a coating chamber which coats the stretchable fiber core with a coating material. The coating material may include high aspect ratio nanomaterials, in powered form, in a volatile solvent solution, or in another form. In some examples, the openings through which the microfiber passes are sufficiently small such that the coating material is held within the chamber by capillary forces.

The stretchable fiber core may be coated with high aspect ratio nanomaterials multiple times. Multiple layers of the same coating material may be applied, or different layers of different coating materials may be applied. Thus, a method for producing a nanomaterial-coated fiber may be modular in that several coatings may be applied at various stages in the method.

At block 708, a mesh of high aspect ratio nanomaterials is formed around the stretchable fiber core. The mesh may be similar to the mesh 120 of FIG. 1. The mesh imparts a material property to the nanomaterial-coated fiber continuous throughout a length of the nanomaterial-coated fiber. The mesh maintains the material property upon stretching of the length of the nanomaterial-coated fiber. Where the method 700 is used to produce an electrically conductive nanomaterial-coated fiber, the high aspect ratio nanomaterials are electrically conductive, and the material property is electrical conductivity. Thus, in such examples, the mesh is an electrically conductive mesh of the electrically conductive high aspect ratio nanomaterials around the stretchable fiber core, the electrically conductive mesh continuously conductive throughout a length of the nanomaterial-coated fiber, the electrically conductive mesh maintaining conductivity upon stretching of the length of the nanomaterial-coated fiber. The method 700 is ended at block 710.

The method 700 may further comprise skewing the high aspect ratio nanomaterials toward alignment with a circumferential direction perpendicular to the length of the nanomaterial-coated fiber. Thus, the stretchable fiber core may have a longitudinal direction and a circumferential direction travelling around the circumference of the stretchable fiber core, and the high aspect ratio nanomaterials may be skewed toward alignment with the circumferential direction. To skew alignment of the high aspect ratio nanomaterials, the high aspect ratio nanomaterials may be shear aligned by, for example, rotating the stretchable fiber core as it passes through a coating of high aspect ratio nanomaterials, or by rotating the apparatus applying the coating.

The method 700 may further comprise treating the stretchable fiber core to enhance adhesion of the mesh to the stretchable fiber core. Treatment to enhance adhesion may involve, for example, swelling the surface of the stretchable fiber core with a volatile solvent, or by partially melting and/or softening the surface of the stretchable fiber core with applied heat. Where the treatment involves swelling the surface of the stretchable fiber core with a volatile solvent, the volatile solvent may include toluene, acetone, methanol, acetonitrile, cyclohexanone, or tetrahydrofuran.

Where the method 700 is used to produce an electrically conductive nanomaterial-coated fiber, the method 700 may further comprise coating the electrically conductive mesh with an electrically insulative layer.

The method 700 need not be performed in the exact sequence as shown. Certain blocks of the method 700 may be combined together or broken down into further blocks.

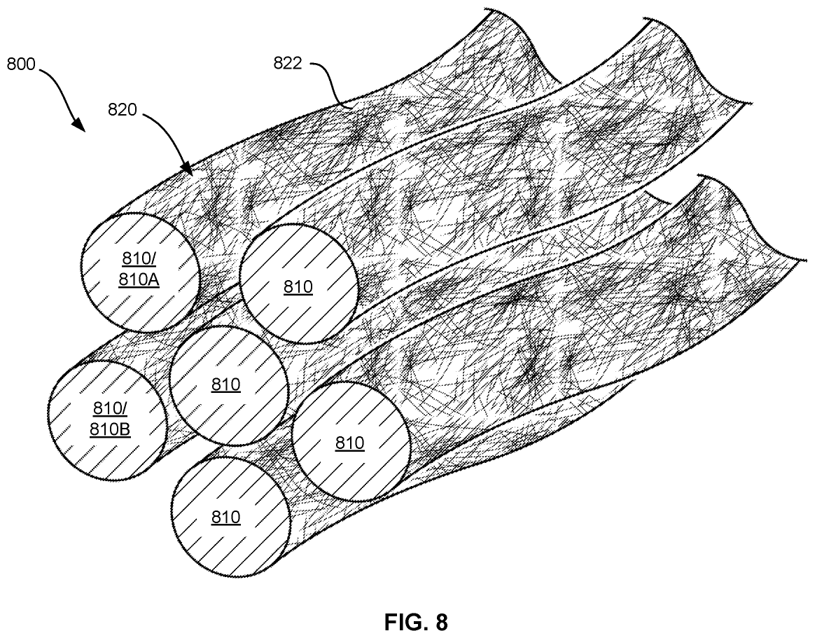

FIG. 8 is an illustration of a segment of an example yarn 800 of nanomaterial-coated fibers. The yarn 800 includes a plurality of stretchable fiber cores 810 wound together. For example, the yarn 800 includes at least a first stretchable fiber core 810A and a second stretchable fiber core 8108 wound together with the first stretchable fiber core 810A. The yarn 800 may include several more stretchable fiber cores 810, such as, for examples about 75 or about 100 stretchable fiber cores 810 wound together. A stretchable fiber core 810 may be similar to the stretchable fiber core 110 of FIG. 1, for which the description of FIG. 1 may be referenced for further description.

The yarn 800 includes a mesh 820 of high aspect ratio nanomaterials 822 coated around the yarn 800 and between the stretchable fiber cores 810, for example, between the first stretchable fiber core 810A and the second stretchable fiber core 8108. The mesh 820 may be similar to the mesh 120 of FIG. 1, for which the description of FIG. 1 may be referenced for further description. Thus, the mesh 820 is to impart a material property to the yarn 800 of nanomaterial-coated fibers 822 continuous throughout a length of the yarn 800 of nanomaterial-coated fibers 822. The mesh 820 is further to maintain the material property upon stretching of the length of the yarn 800 of nanomaterial-coated fibers 822.

Similar to as described above with respect to the nanomaterial-coated fiber 100 of FIG. 1, the material property imparted by the mesh 820 may include any material property attributable to the overall yarn 800 of nanomaterial-coated fibers that emerges as a result of the cooperation of a plurality of high aspect ratio nanomaterials 822 having certain properties and forming a mesh 820 around the yarn 800 and between the stretchable fiber cores 810. The mesh 120 may span the entire length of the nanomaterial-coated yarn 800, or at least a length of a segment thereof, to impart the material property to a length of the yarn 800 of nanomaterial-coated fibers. The mesh 820 being formed both around the outside of the yarn 800 and between the stretchable fiber cores 810 may impart a more stable material property, such as more stable electrical conductivity, to the yarn 800.

For example, the high aspect ratio nanomaterials 822 may be electrically conductive, and the material property may be electrical conductivity. In other words, the electrical conductivity of each individual high aspect ratio nanomaterial 822 is combined to impart overall electrical conductivity to the yarn 800 of nanomaterial-coated fibers. In such examples, the yarn 800 of nanomaterial-coated fibers may be termed a yarn of electrically conductive nanomaterial-coated fibers. Such a yarn of electrically conductive nanomaterial-coated fibers includes a first stretchable fiber core, a second stretchable fiber core wound together with the first stretchable fiber core to form a yarn, and an electrically conductive mesh of electrically conductive high aspect ratio nanomaterials coated around the yarn and between first stretchable fiber core and the second stretchable fiber core, the electrically conductive mesh to conduct electricity throughout a length of the yarn of electrically conductive nanomaterial-coated fibers, the electrically conductive mesh further to maintain electrical conductivity upon stretching of the length of the yarn of electrically conductive nanomaterial-coated fibers. For example, a yarn of about 100 stretchable fiber cores each having a diameter of about 10 micrometers may be wound together, coated with an electrically conductive mesh, and may maintain resistivity below about 1 ohm/cm during and after stretching by up to about 50 percent.

In the example where the yarn 800 is electrically conductive, bundling together many stretchable fiber cores into a yarn may provide improved properties such as conductivity, elongation at break, and maintenance of conductivity upon elongation. The conductivity of such a yarn depends on the freedom of electrons to move through the conductive mesh, which is improved when the mesh is both around the yarn and between individual stretchable fiber cores of the yarn.

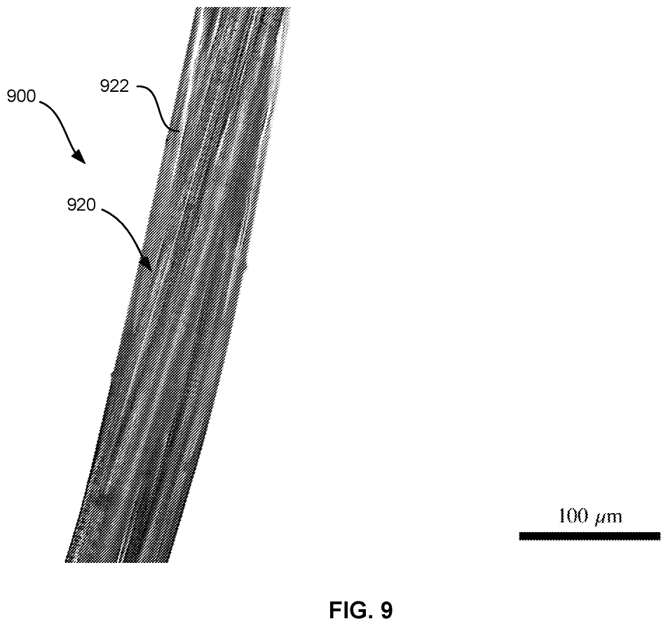

FIG. 9 is a microscopy image of a segment of an example yarn 900 of nanomaterial-coated fibers. The microscopy image was captured using optical microscopy. The yarn 900 shown is similar to the yarn 800 of nanomaterial-coated fibers of FIG. 8, and thus includes a plurality of stretchable fiber cores and a mesh 920 of high aspect ratio nanomaterials 922 around the yarn 900 and between the stretchable fiber cores. For further description of the above elements, description of the yarn 800 of nanomaterial-coated fibers of FIG. 8 may be referenced.

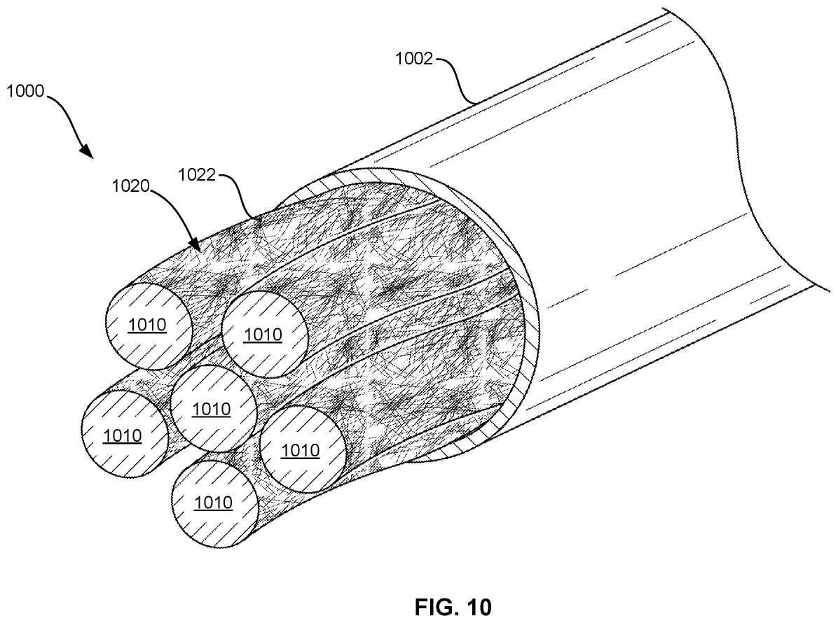

FIG. 10 is an illustration of a segment of an example yarn 1000 of nanomaterial-coated fibers. The yarn 1000 is similar to the yarn 800 of FIG. 8, and thus includes a plurality of stretchable fiber cores 1010 and a mesh 1020 of high aspect ratio nanomaterials 1022 around the yarn 1000 and between the stretchable fiber cores 1010. For further description of the above elements, description of the yarn 800 of nanomaterial-coated fibers of FIG. 8 may be referenced.

The yarn 1000 further includes an insulative layer 1002 surrounding the mesh 1020. Where the yarn 1000 is a yarn of electrically conductive nanomaterial-coated fibers, the insulative layer 1002 provides electrical insulation of the yarn 1000.

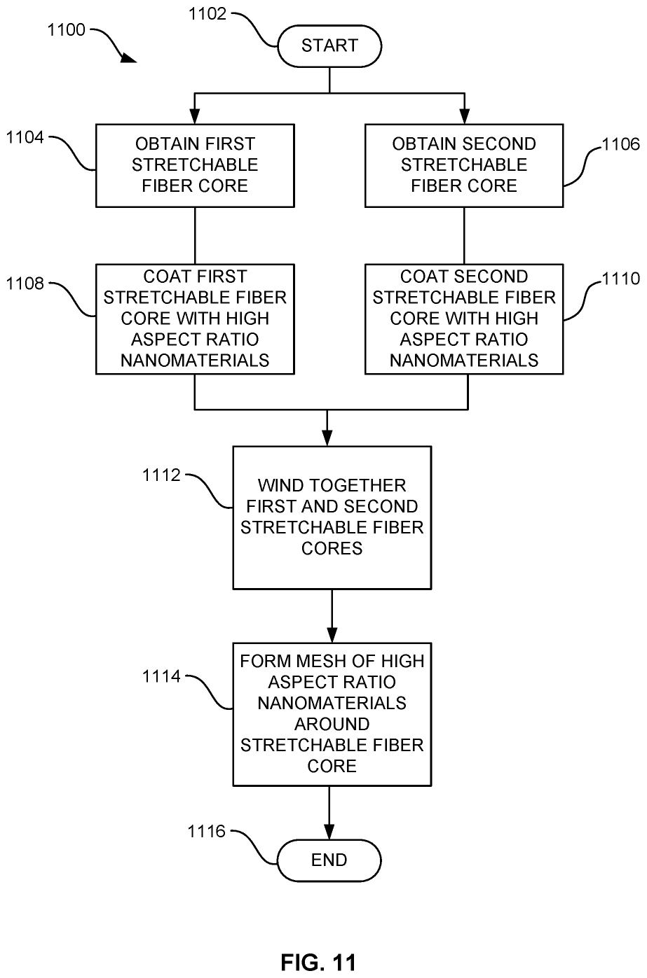

FIG. 11 is a flowchart of an example method 1100 for producing a yarn of nanomaterial-coated fibers. The method 1100 may be used to produce a yarn of nanomaterial-coated fibers such as, for example, the yarn 800 nanomaterial-coated fibers of FIG. 8. Thus, the method 1100 may be used to produce a yarn of electrically conductive nanomaterial-coated fibers. The method 1100 begins at block 1102.

At block 1104, a first stretchable fiber core is obtained. The first stretchable fiber core may be similar to the first stretchable fiber core 810A of FIG. 8. At block 1106, a second stretchable fiber core is obtained. The second stretchable fiber core may be similar to the second stretchable fiber core 8108 of FIG. 8. The first and second stretchable fibers may be obtained in parallel or in any order. Obtaining a stretchable fiber core may be similar to block 704 of method 700 of FIG. 7, which may be referenced for further description.

At block 1108, the first stretchable fiber core is coated with high aspect ratio nanomaterials. At block 1110, the second stretchable fiber core is coated with high aspect ratio nanomaterials. The high aspect ratio nanomaterials may be similar to the high aspect ratio nanomaterials 822 of FIG. 8. The first and second stretchable fibers may be coated in parallel or in any order. Where the method 1100 is used to produce an electrically conductive nanomaterial-coated fiber, the high aspect ratio nanomaterials are electrically conductive.

At block 1112, the first and second stretchable fiber cores are wound together to form a yarn. A yarn may be produced by mechanically twisting many individual stretchable fiber cores together or by winding multiple stretchable fiber cores around each other.

At block 1114, a mesh of high aspect ratio nanomaterials is formed around the yarn of stretchable fiber cores. The mesh may be similar to the mesh 820 of FIG. 8. The mesh imparts a material property to the yarn of nanomaterial-coated fibers continuous throughout a length of the yarn of nanomaterial-coated fibers. The mesh maintains the material property upon stretching of the length of the yarn of nanomaterial-coated fibers. For example, the high aspect ratio nanomaterials may be electrically conductive, and the material property may be electrical conductivity. Where the method 1100 is used to produce a yarn of electrically conductive nanomaterial-coated fibers, the high aspect ratio nanomaterials are electrically conductive, and the material property is electrical conductivity. Thus, in such examples, the mesh is an electrically conductive mesh of the electrically conductive high aspect ratio nanomaterials around the yarn and between the first stretchable fiber core and the second stretchable fiber core, the electrically conductive mesh continuously conductive throughout a length of the nanomaterial-coated fiber, the electrically conductive mesh maintaining conductivity upon stretching of the length of the nanomaterial-coated fiber. The method 1100 is ended at block 1116.

The method 1100 may further comprise skewing the electrically conductive high aspect ratio nanomaterials toward alignment with the length of the yarn of electrically conductive nanomaterial-coated fibers.

Where the method 1100 is used to produce an electrically conductive nanomaterial-coated fiber, the method 1100 may further comprise coating the electrically conductive mesh with an electrically insulative layer.

The method 1100 need not be performed in the exact sequence as shown. Certain blocks of the method 1100 may be combined together or broken down into further blocks. For example, the first and second stretchable fiber cores may be obtained and coated in any order. Further, in other examples, the first and second stretchable fiber core may be wound together to form a yarn before being coated with high aspect ratio nanomaterials.

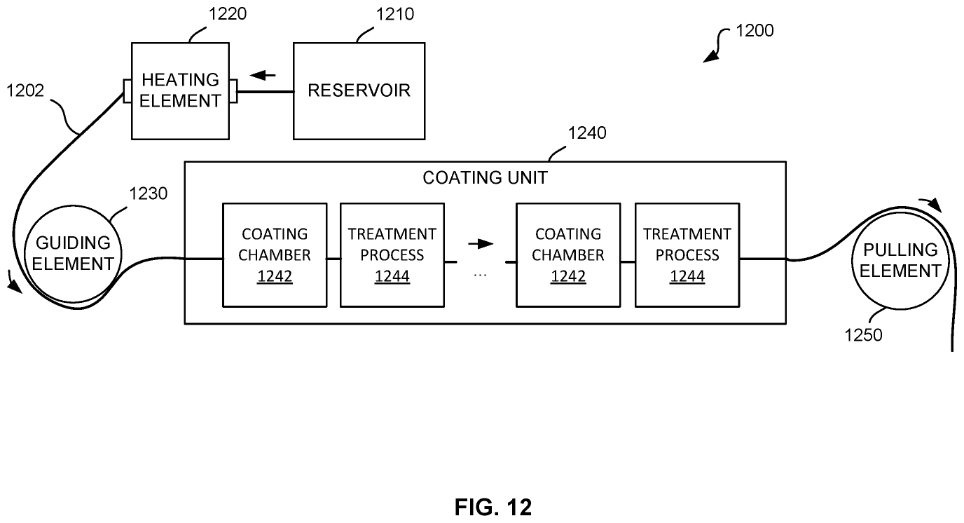

FIG. 12 is an example apparatus 1200 for producing a nanomaterial-coated fiber. The apparatus 1200 is one example apparatus that may be used to perform one variation of the method 700 of FIG. 7. The apparatus 1200 includes a reservoir 1210 to maintain a polymeric material and a heating element 1220 to melt and extrude the polymeric material 1202 to be used to form a stretchable fiber core of a nanomaterial-coated fiber. The apparatus 1200 further includes a guiding element 1230 to guide the polymeric material 1202 into a coating unit 1240 and a pulling element 1250 to pull the polymeric material 1202 through and from the coating unit 1240.

The coating unit 1240 includes one or more coating chambers 1242 and treatment processes 1244. A coating chamber 1242 may apply a coating of high aspect ratio nanomaterials to the polymeric material 1202. For coating chambers 1242 containing dry solid coating material, such as silver nanoparticle powder, before entering the coating chamber 1242, the polymeric material 1202 may be passed through a solvent which wets the polymeric material 1202 and causes the coating material to adhere to the polymeric material 1202. As the wetted polymeric material 1202 passes through the following coating chamber 1242, the dry coating material adheres to the wetted polymeric material 1202 and any residual solvent rapidly evaporates leaving behind a thin solid coating. A coating chamber 1242 may apply a solution of coating material, such as silver nanowire dispersed in ethanol, onto the polymeric material 1202 as it is passed through the coating chamber 1242 in a mechanism similar to dip coating. As the polymeric material 1202 exits the coating chamber 1242 the rapid evaporation of solvent at the liquid air interface leaves behind a thin layer of solid coating material. The speed at which the polymeric material is passed through the chamber may determine the resultant thickness of the applied coating.

By passing a polymeric material through a series of coating chambers 1242, multiple coatings may be applied and combinations of conductive and non-conductive materials may be used. In some embodiments a robust thin conductive coating is deposited onto a polymeric material 1202 by passing said polymeric material 1202 through several chambers 1242, each of which contains a conductive coating material, such as silver nanowire, resulting in a conductive fiber with a low linear resistivity, such as of less than about 1000 ohms/cm. In some examples, following the application of a series of conductive coatings, a non-conductive insulating layer is deposited onto the surface of a conductive mesh formed on the polymeric material 1202.

In an example where the polymeric material 1202 includes TPU, the polymeric material 1202 may be coated with silver nanowire via three coating chambers 1242, resulting in a nanomaterial-coated fiber having a linear resistivity between about 10 and about 100 ohm/cm. The first coating chamber 1242 may contain a powder of silver nanowires with an average radius of about 50 nanometers. Prior to passing the polymeric material 1202 through the silver nanowires, the polymeric material 1202 may be passed through a cyclohexanone module which wets the polymeric material 1202. In other examples, the solvent used may be toluene, methanol, acetone, ethanol, tetrahydrofuran, or acetonitrile, for example. Next, the polymeric material 1202 may be passed through two additional coating chambers 1242, each containing a solution of silver nanowires with an average diameter of about 30 nanometers and a length between about 100 and about 200 micrometers dispersed in ethanol at a concentration of about 20 mg/ml. The final silver nanowire coating produced may be less than about 1 micrometer in thickness, and may be controlled by the concentration of coating solution within the coating chambers 1242 and the speed at which the polymeric material 1202 is passed through the coating chambers 1242.

A coating chamber 1242 or the polymeric material 1202 itself may be rotated to skew alignment of high aspect ratio nanomaterials deposited into the polymeric material 1202. In the example of a starting material of a 10-micrometer TPU filament with a 1-micrometer coating of silver nanowires with an average length between about 100 and about 200 micrometers and an average diameter of about 30 nanometers, the silver nanowires may be spiraled around the surface of the polymeric material 1202 by rotating the TPU filament as it is passed through a coating chamber 1242 containing a solution of said nanowires at a concentration of about 20 mg/ml. The pitch of the spiraling nanowires is controlled by the speed at which the polymeric material 1202 is rotated as it is passed through the coating chamber 1242.

A treatment process 1244 includes any apparatus as is applicable to provide a particular treatment to the polymeric material 1202. For example, a treatment process 1244 may include a heating chamber or a heating coil maintained at a temperature near the melting temperature of the polymeric material 1202 to cause partial melting or softening of the outermost layer of the polymeric material 1202 resulting in the strengthening of the interface between the polymeric material 1202 and an applied coating. As another example, a treatment process 1244 includes a chemical application chamber, such as a chamber to treat a polymeric material 1202 with a solvent, such as cyclohexanone, acetone, methanol, toluene, or acetonitrile, to enhance adhesion of a coating to the polymeric material 1202.

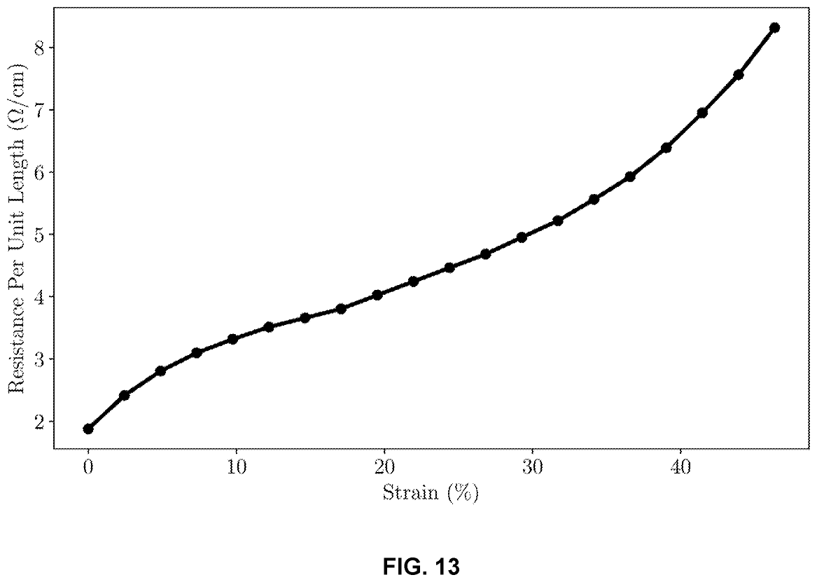

FIG. 13 is a plot showing the electrical resistance (Q/cm) of an example yarn of nanomaterial-coated fibers as a function of strain (%). The example yarn of nanomaterial-coated fibers which was tested includes 60 stretchable fiber cores, each having a diameter of about 30 micrometers, wound together into a yarn having a diameter of about 232 micrometers. The stretchable fiber cores are made of TPU and are coated in a mesh of silver nanowires of about 100 nanometers in thickness around the yarn. The silver nanowires have an average length of about 200 micrometers and diameter of about 30 nanometers, and thus length-to-diameter ratio of about 6667:1. The stretchable fiber cores were treated with heating and with the application of toluene to enhance adhesion between the silver nanowires and the TPU.

The yarn was put under the strain of various degrees of lengthwise elongation. The plot shows that the yarn has a resistance of about 2 Ω/cm at about 0% strain, about 3 Ω/cm at about 10% strain, about 4 Ω/cm at about 20% strain, about 5 Ω/cm at about 30% strain, and about 6 Ω/cm at about 40% strain.

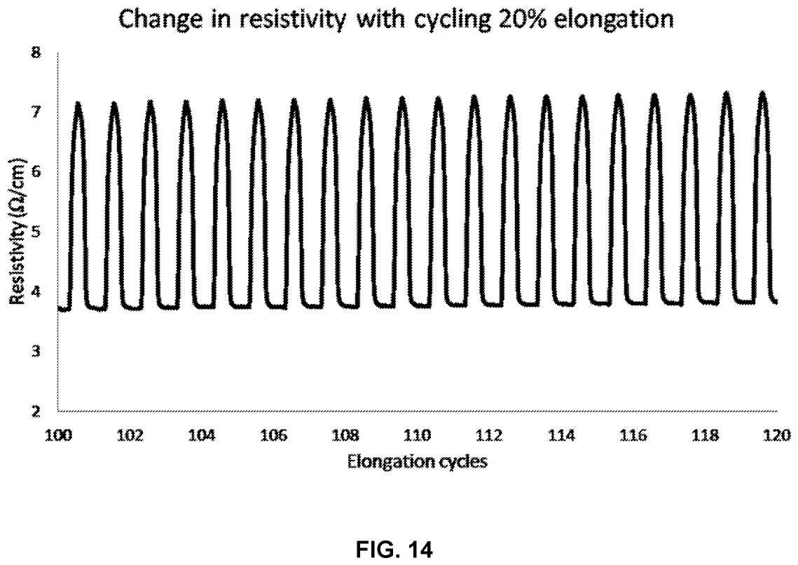

FIG. 14 is a plot showing the electrical resistance (Q/cm) of an example yarn of nanomaterial-coated fibers across a series of elongation cycles. The example yarn of nanomaterial-coated fibers which was tested includes 30 stretchable fiber cores, each having a diameter of about 30 micrometers, wound together into a yarn having a diameter of about 164 micrometers. The stretchable fiber cores are made of TPU and are coated in a mesh of silver nanowires of about 100 nanometers in thickness around the yarn. The silver nanowires have an average length of about 200 micrometers and diameter of about 30 nanometers, and thus length-to-diameter ratio of about 6667:1. The stretchable fiber cores were treated with heating and with the application of toluene to enhance adhesion between the silver nanowires and the TPU.

The yarn was alternately put under the strain of about 20% lengthwise elongation and relaxed, repeatedly for about 120 cycles. The plot shows that the yarn reaches a resistance of about 7 Ω/cm at about 20% strain, and returns to about 4 Ω/cm at rest. The yarn substantially maintains about 7 Ω/cm resistivity at about 20% strain and about 4 Ω/cm resistivity at rest throughout the testing.

A material coating may therefore provide a desirable material property possessed by the material to the fiber without undesirable side effects that may otherwise be suffered if the fiber were made from the material itself. For example, a fiber may be made electrically conductive without undue rigidity.

The scope of the claims should not be limited by the above examples but should be given the broadest interpretation consistent with the description as a whole.

1. A nanomaterial-coated fiber comprising:
a stretchable fiber core; and
a mesh of high aspect ratio nanomaterials coated around the stretchable fiber core, the mesh to impart a material property to the nanomaterial-coated fiber continuous throughout a length of the nanomaterial-coated fiber, the mesh further to maintain the material property upon stretching of the length of the nanomaterial-coated fiber.

2. The nanomaterial-coated fiber of claim 1, wherein the high aspect ratio nanomaterials are electrically conductive and the material property is electrical conductivity.

3. The nanomaterial-coated fiber of claim 1, wherein the stretchable fiber core comprises a polymer.

4. The nanomaterial-coated fiber of claim 1, wherein the stretchable fiber core is stretchable by at least about 10 percent.

5. The nanomaterial-coated fiber of claim 1, wherein the stretchable fiber core has a radius of less than about 1 millimeter.

6. The nanomaterial-coated fiber of claim 1, wherein the high aspect ratio nanomaterials have an average length-to-diameter aspect ratio of at least about 500:1.

7. The nanomaterial-coated fiber of claim 1, wherein the high aspect ratio nanomaterials have an average diameter of less than about 50 nanometers.

8. The nanomaterial-coated fiber of claim 1, further comprising a treatment layer around the mesh of high aspect ratio nanomaterials.

9. The nanomaterial-coated fiber of claim 1, wherein the high aspect ratio nanomaterials of the mesh are skewed toward alignment with a circumferential direction perpendicular to the length of the nanomaterial-coated fiber.

10. A yarn of nanomaterial-coated fibers comprising:
a first stretchable fiber core;
a second stretchable fiber core wound together with the first stretchable fiber core to form a yarn; and
a mesh of high aspect ratio nanomaterials coated around the yarn and between the first stretchable fiber core and the second stretchable fiber core, the mesh to impart a material property to the yarn of nanomaterial-coated fibers continuous throughout a length of the yarn of nanomaterial-coated fibers, the mesh further to maintain the material property upon stretching of the length of the yarn of nanomaterial-coated fibers.

11. The yarn of nanomaterial-coated fibers of claim 10, wherein the high aspect ratio nanomaterials are electrically conductive and the material property is electrical conductivity.

12. A method comprising:
obtaining a stretchable fiber core;
coating the stretchable fiber core with high aspect ratio nanomaterials, and forming a mesh of the high aspect ratio nanomaterials around the stretchable fiber core to produce a nanomaterial-coated fiber, the mesh imparting a material property to the nanomaterial-coated fiber continuous throughout a length of the nanomaterial-coated fiber, the mesh maintaining the material property upon stretching of the length of the nanomaterial-coated fiber.

13. The method of claim 12, wherein the high aspect ratio nanomaterials are electrically conductive and the material property is electrical conductivity.

14. The method of claim 12, further comprising skewing the high aspect ratio nanomaterials toward alignment with a circumferential direction perpendicular to the length of the nanomaterial-coated fiber.

15. The method of claim 12, further comprising:
obtaining a second stretchable fiber core;
coating the second stretchable fiber core with high aspect ratio nanomaterials;
winding together the first stretchable fiber core and the second stretchable fiber core to form a yarn; and
wherein forming the mesh of the high aspect ratio nanomaterials comprises forming the mesh around the yarn and between the first stretchable fiber core and the second stretchable fiber core, the mesh imparting a material property to the yarn of nanomaterial-coated fibers continuous throughout a length of the yarn of nanomaterial-coated fibers, the mesh maintaining the material property upon stretching of the length of the yarn of nanomaterial-coated fibers.

16. The method of claim 15, wherein the high aspect ratio nanomaterials are electrically conductive and the material property is electrical conductivity.

17. The method of claim 15, further comprising skewing the high aspect ratio nanomaterials toward alignment with a circumferential direction perpendicular to the length of the yarn of nanomaterial-coated fiber.

18-27. (canceled)
